(19) United States
(12) Patent Application Publication
(10) Pub. No.: US 2026/0177287 A1
(43) Pub. Date: Jun. 25, 2026

(54) HEAT TRANSFER SYSTEM

(71) Applicant: Bradford White Corporation, Ambler, PA (US)

(72) Inventor: Jonathan Francis Vincent, Middleville, MI (US)

(21) Appl. No.: 19/406,184

(22) Filed: Dec. 2, 2025

Related U.S. Application Data
(60) Provisional application No. 63/736,094, filed on Dec. 19, 2024.

(51) Int. Cl. F24H 15/36; F24D 19/00; F24H 15/215; F24H 15/219; F24H 15/238; G05D 23/19

(52) U.S. Cl. CPC F24H 15/36; F24D 19/0092; F24H 15/215; F24H 15/219; F24H 15/238; G05D 23/1917

(57) ABSTRACT

A heat transfer system includes a fluid flow path with a fluid inlet line and a fluid outlet line downstream of the fluid inlet line, a heat exchanger between the fluid inlet and outlet lines wherein heat generated by a heat generation system is transferred to fluid within the fluid flow path, a first temperature sensor which detects a first temperature of fluid flowing through a first portion of the fluid flow path, a second temperature sensor which detects a second temperature of fluid flowing through a second portion of the fluid flow path downstream of the first portion of the fluid flow path, and control circuitry. The control circuitry determines, without utilizing a fluid flow rate sensor, a flow rate of fluid within the fluid flow path based on the first and second temperatures and controls operation of the heat generation system based on the determined flow rate.

### CROSS-REFERENCE TO RELATED APPLICATIONS

This application claims priority to U.S. Provisional Application No. 63/736,094, filed on Dec. 19, 2024, entitled “HEAT TRANSFER SYSTEM,” the disclosure of which is hereby incorporated herein by reference in its entirety.

### FIELD OF THE DISCLOSURE

The present disclosure generally relates to a heat transfer system. More specifically, the present disclosure relates to a heat transfer system for transferring heat to a fluid, such as water via a water heating system.

### BACKGROUND OF THE DISCLOSURE

Scaling occurs when dissolved minerals, such as calcium carbonate, magnesium carbonate, and other hard water deposits, precipitate out of the water and adhere to the internal surfaces of a fluid flow. This phenomenon is particularly common in water heaters exposed to hard water or operating at high temperatures, where dissolved minerals are less soluble and tend to form solid deposits.

As water is heated, minerals begin to precipitate out of the water and adhere to the walls of the fluid flow path. The initial layer of scale serves as a substrate for further mineral deposition, causing the scale layer to grow thicker over time. As the scale layer grows, it progressively narrows the internal diameter of the fluid flow path, reducing its cross-sectional area. Increased flow resistance results, as the narrowed flow path creates a physical obstruction to water flow increasing hydraulic resistance. Reduced flow rate of water within the fluid flow path follows.

With a lower flow rate, water spends more time in contact with the heat exchanger's heated surfaces. This extended residence time allows the water to heat to a hotter temperature as it flows through the scaled fluid flow path. The prolonged exposure to heat typically results in water being heated to an undesirably high temperature compared to water flowing through a non-scaled, unrestricted fluid flow path at a higher flow rate.

### SUMMARY OF THE DISCLOSURE

According to a first aspect of the present disclosure, a heat transfer system includes a fluid flow path that includes a fluid inlet line and a fluid outlet line disposed downstream of the fluid inlet line, a heat exchanger interposed between the fluid inlet line and the fluid outlet line wherein heat generated via operation of a heat generation system is transferred to fluid within the fluid flow path, a first temperature sensor configured to detect a first temperature indicative of a temperature of fluid flowing through a first portion of the fluid flow path, a second temperature sensor configured to detect a second temperature indicative of a temperature of fluid flowing through a second portion of the fluid flow path that is downstream of the first portion of the fluid flow path, and control circuitry. The control circuitry is configured to determine, without utilizing a fluid flow rate sensor, a flow rate of fluid within the fluid flow path based on the first temperature and the second temperature, and control operation of the heat generation system based on the determined flow rate.

Embodiments of the first aspect of the present disclosure can include any one or a combination of the following features:
the control circuitry is configured to determine the flow rate of fluid within the fluid flow path based on a difference between the first temperature and the second temperature;
the control circuitry is configured to control operation of the heat generation system below a first thermal output rate during a test period preceding determination of the flow rate of the fluid within the fluid flow path;
the control circuitry is configured to control operation of the heat generation system above the first thermal output rate after the test period based on the determined flow rate of the fluid within the fluid flow path being above a threshold;
the control circuitry is configured to control operation of the heat generation system below the first thermal output rate after the test period based on the determined flow rate of the fluid within the fluid flow path being below a threshold;
the control circuitry is configured to terminate operation of the heat generation system after the test period based on the determined flow rate of the fluid within the fluid flow path being below a threshold;
an output device operably coupled with the control circuitry, wherein the control circuitry is configured to control the output device to output an alert based on the determined flow rate of the fluid within the fluid flow path being below a threshold; and
the alert relates to scaling.

According to a second aspect of the present disclosure, a heat transfer system includes a fluid flow path that includes a fluid inlet line and a fluid outlet line disposed downstream of the fluid inlet line, a heat exchanger interposed between the fluid inlet line and the fluid outlet line wherein heat generated via operation of a heat generation system is transferred to fluid within the fluid flow path, a first temperature sensor configured to detect a first temperature indicative of a temperature of fluid flowing through a first portion of the fluid flow path, a second temperature sensor configured to detect a second temperature indicative of a temperature of fluid flowing through a second portion of the fluid flow path that is downstream of the first portion of the fluid flow path, and control circuitry. The control circuitry controls operation of the heat generation system below a first thermal output rate during a test period, determines a difference between the first temperature and the second temperature, and controls operation of the heat generation system above the first thermal output rate after the test period based on the determined difference between the first temperature and the second temperature.

Embodiments of the second aspect of the present disclosure can include any one or a combination of the following features:
the control circuitry determines, without utilizing a fluid flow rate sensor, a flow rate of fluid within the fluid flow path based on the determined difference between the first temperature and the second temperature;
the control circuitry controls operation of the heat generation system above the first thermal output rate after the test period based on the determined difference between the first temperature and the second temperature by utilizing the flow rate of the fluid within the fluid flow path that is determined based on the difference between the first temperature and the second temperature;
the control circuitry is configured to control operation of the heat generation system to continue below the first thermal output rate based on a determination that the flow rate is below a threshold;
the control circuitry is configured to terminate operation of the heat generation system based on a determination that the flow rate is below a threshold;
an output device operably coupled with the control circuitry, wherein the control circuitry is configured to control the output device to output an alert based on a determination that the flow rate of the fluid within the fluid flow path is below a threshold; and
the alert relates to scaling.

According to a third aspect of the present disclosure, a method of heating water via a heat transfer system includes the steps of providing a heat demand signal to control circuitry of the heat transfer system; initiating, via the control circuitry, a test period responsive to the heat demand signal; operating a heat generation system below a first thermal output rate during the test period to generate heat that is transferred to fluid flowing within a fluid flow path; detecting, with a first temperature sensor, a first temperature indicative of a temperature of fluid flowing through a first portion of the fluid flow path during the test period; detecting, with a second temperature sensor, a second temperature indicative of a temperature of fluid flowing through a second portion of the fluid flow path that is downstream of the first portion of the fluid flow path during the test period; determining, via the control circuitry, a flow rate of fluid within the fluid flow path based on a difference between the first temperature and the second temperature; and operating the heat generation system after the test period based on the heat demand signal and the determined flow rate.

Embodiments of the third aspect of the present disclosure can include any one or a combination of the following features:
after the test period, the heat generation system is operated above the first thermal output rate based on a determination that the flow rate of the fluid within the fluid flow path is above a threshold;
the step of operating the heat generation system after the test period comprises operating the heat generation system below the first thermal output rate after the test period based on the heat demand signal and the determined flow rate;
the heat generation system is operated below the first thermal output rate after the test period based on a determination that the flow rate of the fluid within the fluid flow path is below a threshold; and
the first thermal output rate is below a maximum thermal output rate of the heat generation system.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a water heating system, according to one embodiment;

FIG. 2 is a cross-sectional view of a heat exchanger of a heat transfer system that includes a fluid flow path having a fluid inlet line and a fluid outlet line, a heat generation system configured to generate heat that is then transferred to fluid within the fluid flow path, a first temperature sensor and a second temperature sensor, according to one embodiment;

FIG. 3 is a schematic of a heat transfer system, illustrating control circuitry, a sensing system, a heat generation system, and an output device of the heat transfer system, according to one embodiment; and

FIG. 4 is a flow diagram of a method of heating water via a heat transfer system, according to one embodiment.

### DETAILED DESCRIPTION OF PREFERRED EMBODIMENTS

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

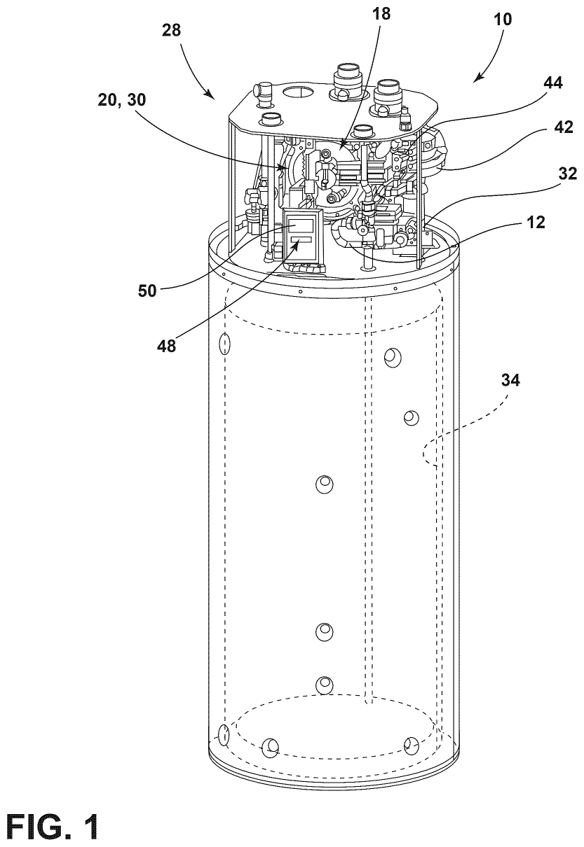

Referring now to FIGS. 1-4, a heat transfer system 10 includes a fluid flow path 12. The fluid flow path 12 includes a fluid inlet line 14 and a fluid outlet line 16 disposed downstream of the fluid inlet line 14. A heat exchanger 18 is interposed between the fluid inlet line 14 and the fluid outlet line 16. Heat generated via a heat generation system 20 is transferred to fluid within the fluid flow path 12 at the heat exchanger 18. A first temperature sensor 22 is configured to detect a first temperature indicative of a temperature of fluid flowing through a first portion of the fluid flow path 12. A second temperature sensor 24 is configured to detect a second temperature indicative of a temperature of fluid flowing through a second portion of the fluid flow path 12 that is downstream of the first portion of the fluid flow path 12. Control circuitry 26 of the heat transfer system 10 is configured to determine, without utilizing a fluid flow rate sensor, a flow rate of fluid within the fluid flow path 12 based on the first temperature and the second temperature and control operation of the heat generation system 20 based on the determined flow rate.

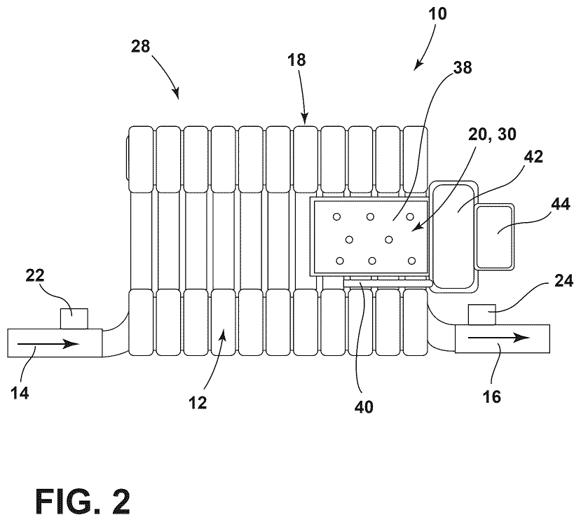

Referring now to FIGS. 1 and 2, the heat transfer system 10 is configured to transfer heat generated via the heat generation system 20 to fluid disposed within the fluid flow path 12 at the heat exchanger 18 of the heat transfer system 10. In various implementations, the fluid is water, and the heat transfer system 10 comprises a water heating system 28. For example, as illustrated in FIG. 1, the heat transfer system 10 is a water heating system 28. In the illustrated embodiment, the water heating system 28 includes the heat exchanger 18 that includes the heat generation system 20 in the form of a combustion heater 30 that utilizes a burner 38 to combust a fuel source, such as natural gas, propane, or another combustible fuel. The heat exchanger 18 further includes the fluid flow path 12 that is disposed between the fluid inlet line 14 and the fluid outlet line 16. In operation of the heat exchanger 18, water is delivered via, for example, a pump 32 from the fluid inlet line 14 through the heat exchanger 18 and to the fluid outlet line 16. The combustion heater 30 generates heat that is transferred to the fluid flowing within the fluid flow path 12. In the exemplary embodiment of the water heating system 28 illustrated in FIG. 1, the water heating system 28 includes a tank 34 that is associated with the heat exchanger 18. It is contemplated that water heated by the heat generation system 20 may be delivered to the tank 34 of the water heating system 28 and/or that water within the tank 34 may be recirculated within the fluid flow path 12 and heated via the heat generation system 20 as described in U.S. patent application Ser. No. 18/886,378, which is incorporated herein by reference in its entirety. In that water heating system 28, water is provided at a substantially constant flow rate via operation of a pump 32 and a valve 33 that controls the flow rate of water within the fluid flow path 12. In some embodiments, the fluid outlet line 16 may extend from the heat exchanger 18 to the tank 34.

Referring now to FIGS. 1-3, the heat generation system 20 can include one or more of a variety of types of heat generation systems 20. In some embodiments, the heat generation system 20 can be the combustion heater 30 that includes the burner 38, an ignitor 40, a blower 42, and a gas valve 44. In some embodiments, the heat generation system 20 can include a heat pump having, for example, a compressor, an evaporator coil, a condenser coil, and a fan. In some implementations, the heat generation system 20 of the heat transfer system 10 can include an electric heating element that is configured to heat water. A variety of types of heat generation systems 20 are contemplated.

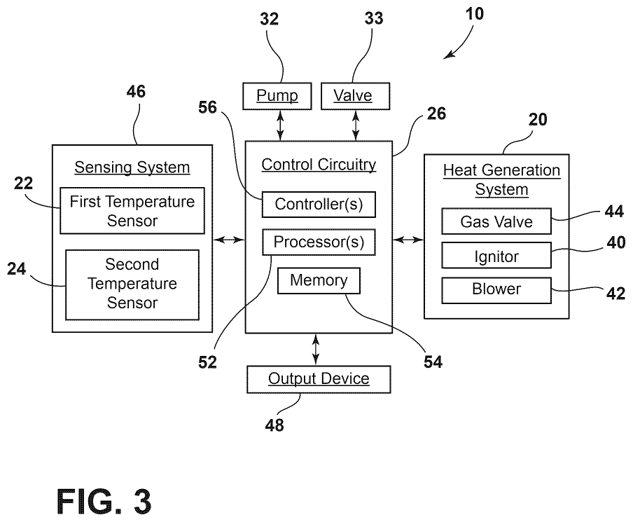

Referring now to FIGS. 2 and 3, in various implementations, the heat transfer system 10 includes a sensing system 46. The sensing system 46 may include a variety of types of sensors (e.g., temperature sensors, pressure sensors, etc.). In an exemplary implementation of the heat transfer system 10, the sensing system 46 of the heat transfer system 10 includes the first temperature sensor 22 and the second temperature sensor 24. The first temperature sensor 22 is configured to detect a first temperature that is indicative of a temperature of fluid flowing through a first portion of the fluid flow path 12. The second temperature sensor 24 is configured to detect a second temperature that is indicative of a temperature of fluid flowing through a second portion of the fluid flow path 12 that is downstream of the first portion of the fluid flow path 12.

In the embodiment illustrated in FIG. 2, the first temperature sensor 22 is coupled to the fluid flow path 12 at the fluid inlet line 14, and the second temperature sensor 24 is coupled to the fluid flow path 12 at the fluid outlet line 16 that is downstream of the fluid inlet line 14. As such, the first and second temperature sensors 22, 24 are operable to detect the first and second temperatures, respectively, that are indicative of the temperature of fluid flowing within different portions of the fluid flow path 12. In the embodiment illustrated in FIG. 2, the first temperature sensor 22 senses the first temperature indicative of fluid flowing through the fluid flow path 12 prior to entering the heat exchanger 18 interposed between the fluid inlet and outlet lines 14, 16, and the second temperature sensor 24 senses the second temperature indicative of the temperature of fluid flowing through the fluid outlet line 16 after flowing through the heat exchanger 18. It is contemplated that the first and/or second temperature sensors 22, 24 may be disposed at various portions along the fluid flow path 12, including at a portion of the fluid flow path 12 that is within the heat exchanger 18 interposed between the fluid inlet and outlet lines 14, 16, in some embodiments. The first and second temperatures sensed by the first and second temperature sensors 22, 24, respectively, may be utilized in determining a flow rate of fluid within the fluid flow path 12 and/or controlling operation of the heat generation system 20 of the heat transfer system 10, as described further herein.

Referring now to FIGS. 1 and 3, the heat transfer system 10 can include an output device 48 that is configured to output an alert. In the embodiment illustrated in FIG. 1, the output device 48 of the heat transfer system 10 is a display screen 50 that is configured to display an alert for the reference of a user. A variety of types of output devices 48 configured to output an alert are contemplated (e.g., indicator lights, speakers, displays, etc.). In an exemplary embodiment, the output device 48 of the heat transfer system 10 may be a remote electronic device, such as a smartphone or computer that is in communication with control circuitry 26 of the heat transfer system 10 via a remote communication protocol, such as Bluetooth or Wi-Fi. As such, the output device 48 may output an alert for the reference of a user of the heat transfer system 10 via the remote electronic device. As described further herein, the alert output by the output device 48 of the heat transfer system 10 may relate to scaling.

Referring still to FIG. 3, the heat transfer system 10 includes the control circuitry 26. The control circuitry 26 of the heat transfer system 10 can be configured with a processor 52 to process logic and routines stored in memory 54 that receives information from the above-described components and/or systems of the heat transfer system 10, including the sensing system 46, the pump 32, the heat generation system 20, the output device 48, and/or one or more valves 33 that works in cooperation with the pump 32. The control circuitry 26 may generate information and commands as a function of all or a portion of the information received. Thereafter, the information and commands may be utilized to control operation of the heat transfer system 10, as described further herein. The control circuitry 26 may include a microprocessor and/or other analog and/or digital circuitry for processing one or more routines. Further, the control circuitry 26 may include the memory 54 for storing one or more routines, such as a demand routine, as described further herein.

It should be appreciated that the control circuitry 26 may include a stand-alone dedicated controller 56 or may include a shared controller 56 integrated with other control functions. In various implementations, the control circuitry 26 can include a plurality of controllers 56. It should further be appreciated that one or more routines or subroutines of the heat transfer system 10 may be carried out by a dedicated processor 52, in some implementations.

Referring now to FIGS. 1-3, the control circuitry 26 is configured to control operation of the heat generation system 20. In various implementations, the control circuitry 26 controls a thermal output rate of the heat generation system 20. In an exemplary embodiment, wherein the heat generation system 20 includes the combustion heater 30, the control circuitry 26 may control the thermal output rate of the heat generation system 20 by controlling the gas valve 44 to control the amount of gas supplied to the burner 38 and/or the blower speed of the blower 42 of the combustion heater 30. In various implementations, the control circuitry 26 is operable to control the heat generation system 20 to generate a thermal output rate in a range between a maximum thermal output rate and a minimum thermal output rate (i.e., zero thermal output) of the heat generation system 20.

Referring still to FIGS. 1-3, the control circuitry 26 is configured to receive sensor data from the sensing system 46. In various implementations, the control circuitry 26 receives sensor data from the first temperature sensor 22 and the second temperature sensor 24 of the sensing system 46. The control circuitry 26 may be configured to control operation of the heat generation system 20 based on the first temperature detected by the first temperature sensor 22 that is indicative of a temperature of fluid flowing through a first portion of the fluid flow path 12 and/or the second temperature detected by the second temperature sensor 24 that is indicative of a temperature of fluid flowing through a second portion of the fluid flow path 12 that is downstream of the first portion of the fluid flow path 12.

In some implementations, the control circuitry 26 determines a difference between the first temperature and the second temperature and controls operation of the heat generation system 20 based on the difference between the first and second temperatures. In some implementations, the control circuitry 26 determines a flow rate of fluid within the fluid flow path 12 based on the determined difference between the first temperature and the second temperature. In some embodiments, the control circuitry 26 determines the flow rate of fluid within the fluid flow path 12 based on the difference between the first and second temperatures without utilizing a fluid flow rate sensor. The control circuitry 26 may be configured to control operation of the heat generation system 20 based on the determined flow rate of the fluid within the fluid flow path 12.

Referring still to FIGS. 1-3, in some implementations, the control circuitry 26 is configured to control operation of the heat generation system 20 below a first thermal output rate during a test period. The test period may be initiated by the control circuitry 26 responsive to a heat demand signal provided to the control circuitry 26 of the heat transfer system 10. The heat demand signal may be provided to the control circuitry 26 based on fulfillment of one or more of a variety of conditions. For example, the heat demand signal may be transmitted to the control circuitry 26 when a sensed temperature of water within the tank 34 of the heat transfer system 10 falls below a setpoint temperature by a predetermined threshold. A variety of triggering conditions are contemplated (e.g., hot water exiting the heat transfer system 10, cold water entering the heat transfer system, user input adjusting setpoint temperature of water, scheduled hot water production window, etc.) The heat demand signal may be provided to the control circuitry 26 based on communications with one or more components and/or systems of the heat transfer system 10 (e.g., sensing system 46).

In various implementations, the first thermal output rate, below which the control circuitry 26 controls the heat generation system 20 to operate during the test period initiated responsive to the heat demand signal, may be lower than the maximum thermal output rate of the heat generation system 20. After conclusion of the test period, the control circuitry 26 may be configured to control operation of the heat generation system 20 based on the first and second temperatures detected by the first and second temperature sensors 22, 24 during the test period, the difference between the first and second temperatures, and/or the fluid flow rate determined based on the difference between the first and second temperatures detected during the test period. In some implementations, the control circuitry 26 is configured to control operation of the heat generation system 20 above the first thermal output rate after the test period based on the determined flow rate of the fluid within the fluid flow path 12 being above a threshold. In some implementations, the control circuitry 26 is configured to control operation of the heat generation system 20 below the first thermal output rate after the test period based on the determined flow rate of the fluid within the fluid flow path 12 being below a threshold. In some implementations, the control circuitry 26 is configured to terminate operation of the heat generation system 20 after or during the test period based on the determined flow rate of the fluid within the fluid flow path 12 being below a threshold.

In practice, the determined flow rate of fluid flowing within the fluid flow path 12 is indicative of the amount of scale within the fluid flow path 12. Generally, the lower the fluid flow rate, the greater the magnitude of scaling. When the fluid flow rate is relatively low, fluid flowing in the fluid flow path 12 is exposed to the heat generated by the heat generation system 20 for a longer than ideal duration, resulting in overheated water. Accordingly, the control circuitry 26 controlling operation of the heat generation system 20 below the first thermal output rate (which is below the maximum thermal output rate of the heat generation system 20) during the test period mitigates the risk of overheating the water flowing within the fluid flow path 12. Further, controlling operation of the heat generation system 20 below the first thermal output rate during the test period allows the first and second temperatures sensors 22, 24 to determine a difference in temperature of the water at different points along the fluid flow path 12, from which the fluid flow rate can be determined. If, at the conclusion of the test period, the determined flow rate is lower than a threshold flow rate (indicating high scaling and potential for overheating of fluid within the fluid flow path 12), the control circuitry 26 can control the heat generation system 20 to continue operating below the first thermal output rate. Conversely, if the determined fluid flow rate is above a threshold (indicating low amounts of scaling and minimal risk of overheating), the control circuitry 26 can control operation of the heat generation system 20 at a thermal output rate that is above the first thermal output rate to heat water flowing within the fluid flow path 12 more quickly.

In some embodiments, the control circuitry 26 may control the output device 48 to output an alert based on the determined flow rate of fluid within the fluid flow path 12. For example, the control circuitry 26 can control the output device 48 to output an alert based on the determined flow rate of the fluid within the fluid flow path 12 being below a threshold. In various implementations, the alert output by the output device 48 may be related to scaling. For example, the alert may be a warning displayed on the display screen 50 of the output device 48 of the heat transfer system 10 illustrated in FIG. 1, stating “service warning, overscaling.” A variety of types of alerts are contemplated.

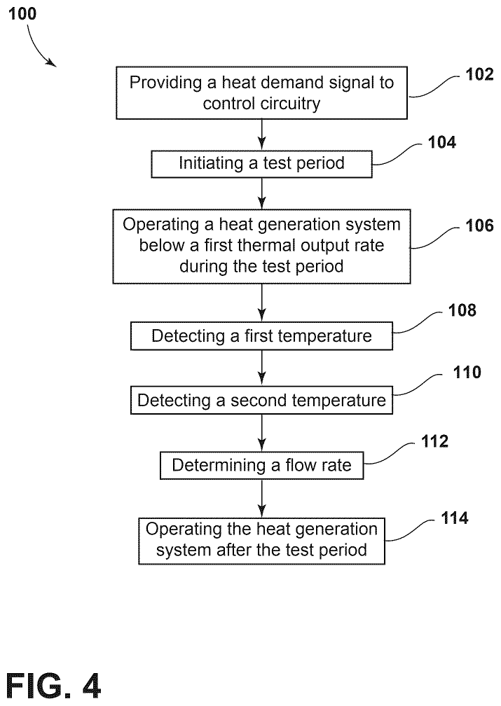

Referring now to FIG. 4, a method 100 of heating water via a heat transfer system 10 is provided. The method 100 can include a step 102 of providing a heat demand signal to control circuitry 26 of the heat transfer system 10. As described above herein, the heat demand signal may be provided to the control circuitry 26 based on fulfillment of one or more of a variety of conditions associated with the heat transfer system 10 (e.g., detected temperature of water within a tank 34 falling below a setpoint temperature, etc.).

The method 100 may further include a step 104 of initiating, via the control circuitry 26, a test period responsive to the heat demand signal. The test period may be for a predetermined duration. In various embodiments, the method 100 may further include a step 106 of operating the heat generation system 20 below the first thermal output rate during the test period to generate heat that is transferred to fluid flowing within the fluid flow path 12. As described herein, the first thermal output rate may be below a maximum thermal output rate of the heat generation system 20.

Referring still to FIG. 4, the method 100 can include the step 108 of detecting, with a first temperature sensor 22, a first temperature indicative of a temperature of fluid flowing through a first portion of the fluid flow path 12 during the test period. Method 100 may further include the step 110 of detecting, with a second temperature sensor 24, a second temperature indicative of a temperature of fluid flowing through a second portion of the fluid flow path 12 that is downstream of the first portion of the fluid flow path 12 during the test period. In various implementations, the heat exchanger 18 is disposed between the first and second portions of the fluid flow path 12, as illustrated in FIG. 2.

Method 100 can include the step 112 of determining, via the control circuitry 26, a flow rate of fluid within the fluid flow path 12 based on a difference between the first temperature and the second temperature. In various implementations, the step 112 of determining the flow rate of fluid based on the difference between the first temperature and the second temperature can be determined without utilizing a fluid flow rate sensor and/or data received from a fluid flow rate sensor.

The method 100 can include the step 114 of operating the heat generation system 20 after the test period, as illustrated in FIG. 4. In various implementations, the step 114 may include operating the heat generation system 20 after the test period based on the first and second temperatures and/or a difference between the first and second temperatures, as described above herein. In some embodiments, the step 114 may include operating the heat generation system 20 after the test period based on the heat demand signal and the determined flow rate. In some implementations, at step 114, the heat generation system 20 is operated above the first thermal output rate based on a determination that the flow rate of fluid within the fluid flow path 12 is above a threshold. In some implementations, the step 114 of operating the heat generation system 20 after the test period comprises operating the heat generation system 20 below the first thermal output rate after the test period based on the heat demand signal and the determined flow rate. For example, the heat generation system 20 may be operated below the first thermal output rate after the test period based on a determination that the flow rate of the fluid within the fluid flow path 12 is below a threshold.

The heat transfer system of the present disclosure may provide a variety of advantages. First, the first and second temperature sensors 22, 24 being positioned at different portions of the fluid flow path 12 allows for detection of a temperature differential along the fluid flow path 12, from which a flow rate of fluid within the fluid flow path 12 can be determined without the use of a fluid flow rate sensor. Second, implementing a test period wherein the heat generation system 20 is controlled at a thermal output rate below a maximum thermal output rate of the heat generation system 20 mitigates the risk of overheating water flowing within the fluid flow path 12, despite the possibility of scaling within the fluid flow path 12. Third, determining the flow rate of fluid within the fluid flow path 12 during the test period based on the first and second detected temperatures enables the control circuitry 26 to control the heat generation system 20 at an appropriate thermal output rate after conclusion of the test period to achieve the desired heated water outcome.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A heat transfer system, comprising:
a fluid flow path that includes a fluid inlet line and a fluid outlet line disposed downstream of the fluid inlet line;
a heat exchanger interposed between the fluid inlet line and the fluid outlet line, wherein heat generated via operation of a heat generation system is transferred to fluid within the fluid flow path;
a first temperature sensor configured to detect a first temperature indicative of a temperature of fluid flowing through a first portion of the fluid flow path;
a second temperature sensor configured to detect a second temperature indicative of a temperature of fluid flowing through a second portion of the fluid flow path that is downstream of the first portion of the fluid flow path; and
control circuitry configured to:
determine, without utilizing a fluid flow rate sensor, a flow rate of fluid within the fluid flow path based on the first temperature and the second temperature; and
control operation of the heat generation system based on the determined flow rate.

2. The heat transfer system of claim 1, wherein the control circuitry is configured to determine the flow rate of fluid within the fluid flow path based on a difference between the first temperature and the second temperature.

3. The heat transfer system of claim 2, wherein the control circuitry is configured to control operation of the heat generation system below a first thermal output rate during a test period preceding determination of the flow rate of the fluid within the fluid flow path.

4. The heat transfer system of claim 3, wherein the control circuitry is configured to control operation of the heat generation system above the first thermal output rate after the test period based on the determined flow rate of the fluid within the fluid flow path being above a threshold.

5. The heat transfer system of claim 3, wherein the control circuitry is configured to control operation of the heat generation system below the first thermal output rate after the test period based on the determined flow rate of the fluid within the fluid flow path being below a threshold.

6. The heat transfer system of claim 3, wherein the control circuitry is configured to terminate operation of the heat generation system after the test period based on the determined flow rate of the fluid within the fluid flow path being below a threshold.

7. The heat transfer system of claim 3, further comprising:
an output device operably coupled with the control circuitry, wherein the control circuitry is configured to control the output device to output an alert based on the determined flow rate of the fluid within the fluid flow path being below a threshold.

8. The heat transfer system of claim 7, wherein the alert relates to scaling.

9. A heat transfer system, comprising:
a fluid flow path that includes a fluid inlet line and a fluid outlet line disposed downstream of the fluid inlet line;
a heat exchanger interposed between the fluid inlet line and the fluid outlet line, wherein heat generated via operation of a heat generation system is transferred to fluid within the fluid flow path;
a first temperature sensor configured to detect a first temperature indicative of a temperature of fluid flowing through a first portion of the fluid flow path;
a second temperature sensor configured to detect a second temperature indicative of a temperature of fluid flowing through a second portion of the fluid flow path that is downstream of the first portion of the fluid flow path; and
control circuitry that:
controls operation of the heat generation system below a first thermal output rate during a test period;
determines a difference between the first temperature and the second temperature; and
controls operation of the heat generation system above the first thermal output rate after the test period based on the determined difference between the first temperature and the second temperature.

10. The heat transfer system of claim 9, wherein the control circuitry determines, without utilizing a fluid flow rate sensor, a flow rate of fluid within the fluid flow path based on the determined difference between the first temperature and the second temperature.

11. The heat transfer system of claim 10, wherein the control circuitry controls operation of the heat generation system above the first thermal output rate after the test period based on the determined difference between the first temperature and the second temperature by utilizing the flow rate of the fluid within the fluid flow path that is determined based on the difference between the first temperature and the second temperature.

12. The heat transfer system of claim 10, wherein the control circuitry is configured to control operation of the heat generation system to continue below the first thermal output rate based on a determination that the flow rate is below a threshold.

13. The heat transfer system of claim 10, wherein the control circuitry is configured to terminate operation of the heat generation system based on a determination that the flow rate is below a threshold.

14. The heat transfer system of claim 10, further comprising:
an output device operably coupled with the control circuitry, wherein the control circuitry is configured to control the output device to output an alert based on a determination that the flow rate of the fluid within the fluid flow path is below a threshold.

15. The heat transfer system of claim 14, wherein the alert relates to scaling.

16. A method of heating water via a heat transfer system, comprising the steps of:
providing a heat demand signal to control circuitry of the heat transfer system;
initiating, via the control circuitry, a test period responsive to the heat demand signal;
operating a heat generation system below a first thermal output rate during the test period to generate heat that is transferred to fluid flowing within a fluid flow path;
detecting, with a first temperature sensor, a first temperature indicative of a temperature of fluid flowing through a first portion of the fluid flow path during the test period;
detecting, with a second temperature sensor, a second temperature indicative of a temperature of fluid flowing through a second portion of the fluid flow path that is downstream of the first portion of the fluid flow path during the test period;
determining, via the control circuitry, a flow rate of fluid within the fluid flow path based on a difference between the first temperature and the second temperature; and
operating the heat generation system after the test period based on the heat demand signal and the determined flow rate.

17. The method of claim 16, wherein, after the test period, the heat generation system is operated above the first thermal output rate based on a determination that the flow rate of the fluid within the fluid flow path is above a threshold.

18. The method of claim 16, wherein the step of operating the heat generation system after the test period comprises operating the heat generation system below the first thermal output rate after the test period based on the heat demand signal and the determined flow rate.

19. The method of claim 18, wherein the heat generation system is operated below the first thermal output rate after the test period based on a determination that the flow rate of the fluid within the fluid flow path is below a threshold.

20. The method of claim 18, wherein the first thermal output rate is below a maximum thermal output rate of the heat generation system.
